(19) United States
(12) Patent Application Publication
(10) Pub. No.: US 2018/0303104 A1
(43) Pub. Date: Oct. 25, 2018

(54) GLUTINOUS RICE CAKE WITH MUGWORT CONTAINING RED BEAN PASTE AND METHOD FOR MANUFACTURING THE SAME

(71) Applicants: Jo Woo LEE, Seoul (KR); Myunghi KIM, Seoul (KR); Jungwan LEE, Seoul (KR)

(72) Inventors: Jo Woo LEE, Seoul (KR); Myunghi KIM, Seoul (KR); Jungwan LEE, Seoul (KR)

(21) Appl. No.: 15/491,793

(22) Filed: Apr. 19, 2017

(51) Int. Cl. A21D 13/047; A21D 2/36

(52) U.S. Cl. CPC A21D 13/047; A21D 2/36; A21D 2/362

(57) ABSTRACT

The present disclosure provides a glutinous rice cake with mugwort containing red bean paste and a method for manufacturing the same. The method for manufacturing a glutinous rice cake with mugwort containing red bean paste includes: (a) pre-treating and freeze-storing mugwort; (b) soaking glutinous rice in water then mixing it with secondary materials including bay salt and sugar; (c) blending the soaked glutinous rice and secondary materials with thawed mugwort and steaming the same to prepare steamed glutinous rice grains with mugwort; and (d) putting the steamed glutinous rice grains with mugwort in a pounding machine, firstly crushing the same to prepare a glutinous rice cake with mugwort, secondly crushing the first-crushed glutinous rice cake with mugwort in the pounding machine, filling the rice cake with red bean paste including walnut powders and forming the mixture into a glutinous rice cake with mugwort containing red bean paste.

### BACKGROUND

### 1. Field

The present disclosure relates to a glutinous rice cake with mugwort containing red bean paste and a method for manufacturing the same.

### 2. Description of the Related Art

Starch of rice includes amylose and amylopectin. In particular, non-glutinous rice is transparent and includes 15 to 20% of amylose and 80 to 85% of amylopectin, while glutinous rice is milky-white, opaque and includes only the amylopectin.

Non-glutinous rice and glutinous rice have a considerable difference from each other in terms of texture thereof, and therefore, when using the glutinous rice to make steamed rice or rice cake, it exhibits increased stickiness compared to the non-glutinous rice. Further, the steamed rice or rice cake made of glutinous rice does not become too hard while retaining springiness and softness for a long time, even if it is left for a long period of time. Therefore, glutinous rice-processed food products may have a considerable difference from one another in terms of qualities thereof.

Korean Patent Registration Publication No. 10-1099619 (a method for manufacturing unhardened rice cake and the rice cake manufactured by the method), Korean Patent Registration Publication No. 10-1464105 (a method for manufacturing a glutinous rice cake and a method for manufacturing a piece type glutinous rice cake using the same), Korean Patent Laid-Open Publication No. 10-2013-74884 (a mugwort rice cake containing salted and mature mugwort and a manufacturing method thereof) and Korean Patent Registration Publication No. 10-1271298 (a method for manufacturing a mugwort rice cake) disclose the related technologies.

### SUMMARY

One aspect of the present invention provides a method for manufacturing a glutinous rice cake with mugwort containing red bean paste, which maintains an original taste and flavor due to pre-treatment of the mugwort while having excellent mouthfeel such as cohesiveness, adhesiveness, springiness, chewiness and gumminess by crushing the steamed glutinous rice.

Another aspect of the present invention provides a glutinous rice cake with mugwort containing red bean paste, which maintains an original taste and flavor due to pre-treatment of the mugwort while having excellent mouthfeel by crushing the steamed glutinous rice.

Still another aspect of the present invention provides a method for manufacturing a glutinous rice cake with mugwort containing red bean paste, including: (a) pre-treating and freeze-storing mugwort; (b) soaking glutinous rice in water then mixing it with secondary materials including bay salt and sugar; (c) blending the soaked glutinous rice and secondary materials with thawed mugwort and steaming the same to prepare steamed glutinous rice grains with mugwort; and (d) putting the steamed glutinous rice grains with mugwort in a pounding machine, firstly crushing the same to prepare a glutinous rice cake with mugwort, secondly crushing the first-crushed glutinous rice cake with mugwort in the pounding machine, filling the rice cake with red bean paste including walnut powders in a forming machine and forming the mixture into a glutinous rice cake with mugwort containing red bean paste in the forming machine.

A further aspect of the present invention provides a glutinous rice cake with mugwort containing red bean paste, which includes 50 to 60% by weight (‘wt. %’) of glutinous rice, 20 to 25 wt. % of mugwort, 17 to 23 wt. % of red bean paste, 2 to 3 wt. % of walnut, 0.1 to 1 wt. % of bay salt and 0.5 to 1.5 wt. % of sugar to a total weight of the glutinous rice cake.

Further, embodiments of the present invention provide a glutinous rice cake with mugwort containing red bean paste manufactured by the above method.

According to embodiments of the present invention, it is possible to provide the glutinous rice cake with mugwort containing red bean paste with an original taste and flavor due to pre-treatment of the mugwort while having excellent mouthfeel by crushing the steamed glutinous rice.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating a manufacturing process of a glutinous rice cake with mugwort containing red bean paste according to embodiments of the present invention;

FIG. 2 is a photograph illustrating the glutinous rice cake with mugwort containing red bean paste according to embodiments of the present invention; and

FIG. 3 is a photograph illustrating a cross-section of the glutinous rice cake with mugwort containing red bean paste according to embodiments of the present invention.

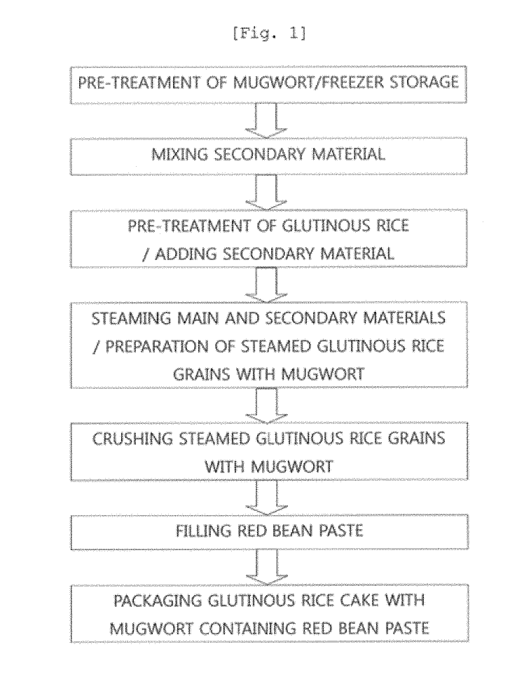

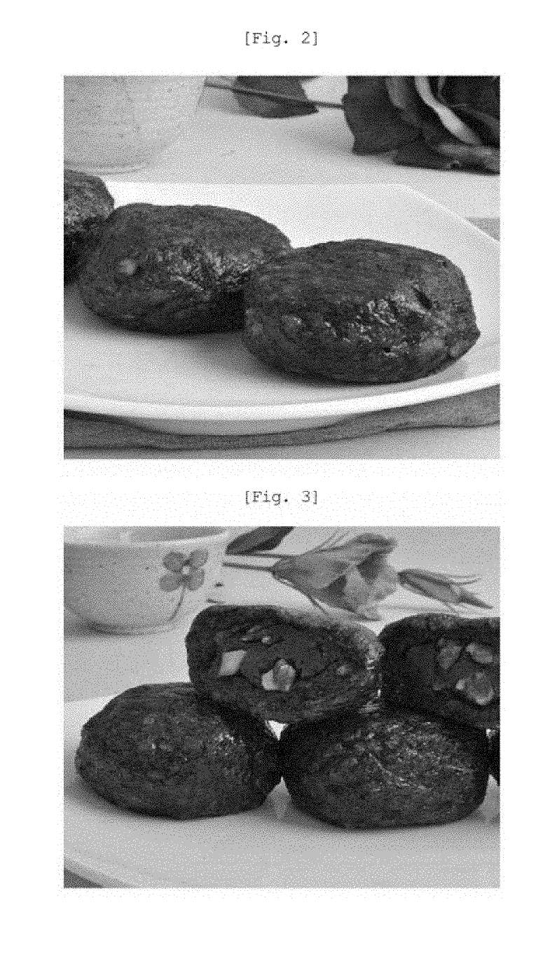

### DETAILED DESCRIPTION OF EMBODIMENTS

Generally, non-glutinous rice and glutinous rice have a considerable difference from each other in terms of texture thereof, and therefore, when using the glutinous rice to make steamed rice or rice cake, it exhibits increased stickiness compared to the non-glutinous rice. Further, the steamed rice or rice cake made of glutinous rice does not become too hard while retaining springiness and softness for a long time, even if it is left for a long period of time. Therefore, glutinous rice-processed food products may have a considerable difference from one another in terms of qualities thereof.

If a product manufactured by gelatinization of glutinous rice is left exposed at room temperature for a long period of time, starch molecules may be linked through hydrogen bonding while water escapes to an outside, thus becoming hard due to retro-gradation to partially form a crystalline structure.

Such retro-gradation of starch may be influenced by types of starch, a compositional ratio of amylose and amylopectin, storage temperature, pH, water content and additives. Accordingly, in order to prevent the retro-gradation of starch, many attempts to perform addition of trehalose, a surfactant, emulsifier, oligosaccharide or raw starch saccharification type amylase have been conducted.

In general, a glutinous rice cake is made by soaking glutinous rice in water, cooking the same, pounding the rice in a mortar, making it sticky, and then cutting the glutinous product into a predetermined size and shape. Immediately after pounding, the starch of glutinous rice cake is gelatinized in an α state and is easy to digest. However, if the rice cake is left exposed, the starch is dried and changed into a β type to become hard with poor taste, and has deteriorated digestibility.

However, when steaming the hard glutinous rice cake, the cake may be returned to the original status, and therefore the starch becomes soft and easy to digest. In one example, a method for manufacturing a rice cake includes: (a) soaking grains in water then removing the water; (b) crushing the water-free grains, adding water, and then re-crushing the same; (c) cooking the re-crushed grains; and (d) after cooling the cooked grains, adding wheat flour and pounding the mixture to form the rice cake. However, the above-described method requires a long manufacturing time since the grains should be crushed several times. Further, since wheat flour is added to the grains, the product is not a pure glutinous rice cake.

In another example, a method for manufacturing a glutinous rice cake includes: washing and soaking glutinous rice in fresh water, dehydrating and crushing the same to prepare crushed glutinous rice; cooking the crushed glutinous rice to prepare a glutinous rice cake base; repeatedly applying impact to the glutinous rice cake base to prepare a glutinous rice cake with increased viscosity; and maturing the glutinous rice cake at a temperature above zero to enhance the flavor of the glutinous rice cake. In fact, the above-described method is characterized by repeatedly applying impact to the glutinous rice cake base, so as to improve the viscosity. However, the methods as described above have technical configurations obviously different from that of the present invention.

In a further example, a method for manufacturing a mugwort rice cake containing salted and mature mugwort includes: salting and maturing mugwort for at least 1 year; pre-treatment of glutinous rice conducted by soaking the glutinous rice in water, then washing and crushing the rice; first steaming the rice to heat the crushed rice powders with steam then process the same into a rice cake state; mixing the first-steamed glutinous rice cake with the salted and mature mugwort then secondly steaming the same; cooling the secondly-steamed mugwort rice cake to 40 to 60° C.; cutting the cooled mugwort rice cake into pieces having a predetermined size; and mixing the cut pieces of mugwort rice cake with each other again then pounding the same. However, the above-described method requires quite a long manufacturing time due to the steaming and cutting processes although stickiness of the glutinous rice cake may be improved, thus the above discussed method may be cumbersome and complicated.

In an alternative example, a method for manufacturing a mugwort rice cake includes: a first process of steaming mugwort leaves with steam for 7 to 13 minutes, washing the same with warm water and dehydrating; a second process of heating 1600 g of glutinous rice powders with steam for 17 to 23 minutes; a third process of adding 1000 g of the mugwort leaves from the first process to the glutinous rice powders from the second process then heating the mixture with steam for 27 to 33 minutes; a fourth process of crushing and extruding the product from the third process through a rice cake extruder; a fifth process of introducing the product from the fourth process into a rice cake pounding machine and pounding the same at 400 to 500 times per minute for 3 to 5 minutes; and a sixth process of individually packaging the product from the fifth process into pieces in an appropriate serving size. However, the above-described method may be cumbersome and complicated.

Furthermore, the glutinous rice cake with mugwort is produced by mixing two primary materials, that is, glutinous rice powders and mugwort in a predetermined ratio thereof, blending the mixture with sugar or salt as a secondary material, steaming the same in a steamer, forming the steamed mixture into a stick of rounded rice cake, glutinous rice cake or half-moon rice cake, and coating the rice cake with stir-fried bean powders, rice powders or pizza powders.

However, such a glutinous rice cake with mugwort as described above has improved hardness, cohesiveness, adhesiveness and gumminess, thus being terribly sticky inside the mouth. Further, due to low springiness or chewiness, the rice cake has a disadvantage of poor mouthfeel.

Additionally, since a mugwort paste or powder is prepared by crushing mugwort leaves, the mouthfeel is reduced. Further, mugwort leaves are sometimes denaturized by enzymes to deteriorate the taste, flavor and color of mugwort.

In embodiments of the present invention, a method for manufacturing a glutinous rice cake with mugwort containing red bean paste includes: (a) pre-treating and freeze-storing mugwort; (b) soaking glutinous rice in water then mixing it with secondary materials including bay salt and sugar; (c) blending the soaked glutinous rice and secondary materials with thawed mugwort and steaming the same to prepare steamed glutinous rice grains with mugwort; and (d) putting the steamed glutinous rice grains with mugwort in a pounding machine, firstly crushing the same to prepare a glutinous rice cake with mugwort, secondly crushing the first-crushed glutinous rice cake with mugwort in the pounding machine, filling the rice cake with red bean paste including walnut powders in a forming machine and forming the mixture into a glutinous rice cake with mugwort containing red bean paste in the forming machine.

Mugwort (wormwood) used in the method for manufacturing a glutinous rice cake with mugwort according to embodiments of the present invention is a perennial plant of a member of the chrysanthemum family. About 38 species of mugworts are present in domestic fields and may include Korean native mugworts, for example, mugwort from Halla mountain, Injin mugwort (‘Injinssuk’) from Gangwon-do or Jiri mountain, herbal mugwort from the west coast, Ganghwa mugwort (‘Sajabalssuk’) from Ganghwa-do, and the like.

The above mugworts are well known to be effective for chronic stomach disorders, anti-parasitic treatment, malodor removal, lower abdominal pain, asthma and hemostasis, and to be helpful for digestion, to clean the blood, while having a beneficial effect as a diuretic, tonic, and beauty enhancer. Further, it has also been reported that mugwort has various biological activities such as anti-inflammatory effect, antimicrobial effect and anticancer effect, decrease of blood ethanol concentration, anti-oxidative effect, etc.

Further, an anti-mutative effect due to an essential oil component of mugwort, liver function protective effect and anti-inflammatory effect of Injin mugwort, etc. have also been reported. Further, various components such as jaceosidin, sesamin, etc. contained in mugwort are known to have specific effects on gastric ulcer, cancer, hyperlipidemia, etc. Broadly, it is known that mugwort is also effective against diabetes and/or various liver dysfunctions.

Since mugwort contains a lot of fiber, it enables smooth and active peristaltic motion of the bowels and secretion of mucus to thus help regular bowel movements. In addition, it is also known that a blood circulating effect of mugwort improves blood circulation, thereby strengthening the stomach and bowels.

In 100 g of young mugwort plant, it has been reported that 5.2 g of protein, 0.8 g of lipid, 4.0 g of glucose, 3.7 g of fiber and 2.0 g of ash are contained, as well as minerals and vitamins such as 93 mg of calcium, 55 mg of phosphorous, 10.9 mg of iron, 7940 IU of vitamin A, 0.44 mg of vitamin B1, 0.16 mg of vitamin B2, 4.5 mg of niacin, 20 mg of vitamin C, and the like, are contained.

Recently, noodles, confectionary, beverage substitutes utilizing unique flavor and taste of mugwort have been developed. Further, after gathering stems and leaves of mugwort and drying the same in the shade, the dried mugwort has been widely used for medicine. In addition, dried mugwort has also been used to make tea or as a material for food such as soup, rice cake, pan cake, seasoned greens, or the like.

Among them, in particular, mugwort rice cake is currently made and eaten according to an old custom involving gathering mugwort leaves, crushing and adding the same to non-glutinous rice powders, kneading the mixture to bring out a green color, and then making the kneaded paste into imprinted rice cake.

In the method for manufacturing a glutinous rice cake with mugwort according to embodiments of the present invention, the step (a) may include: cutting mugwort leaves and stems into pieces having a size of ⅛ to 1/12 of an original size; parboiling the pieces in hot water at 100 to 120° C. for 1 to 3 minutes to deactivate enzymes; firstly dehydrating the parboiled mugwort to remove 15 to 25% of water content; and freezing and storing the dehydrated mugwort in a freezer at −10 to −30° C.

In the method for manufacturing a glutinous rice cake with mugwort according to embodiments of the present invention, the step (b) may include: naturally thawing the frozen mugwort at room temperature; secondly dehydrating the mugwort to remove 35 to 45% of water content; and mixing the mugwort with glutinous rice soaked in water and secondary materials.

According to the method for manufacturing a glutinous rice cake with mugwort according to embodiments of the present invention, a total crushing ratio of the glutinous rice cake with mugwort may range from 30 to 70%.

According to the method for manufacturing a glutinous rice cake with mugwort according to embodiments of the present invention, if the total crushing ratio of the glutinous rice cake with mugwort is generally less than 30% (not absolute) or generally exceeds 70% (not absolute), the rice cake may involve deteriorated mouthfeel.

The red bean paste (adzuki bean sediment) used in the method for manufacturing a glutinous rice cake with mugwort according to embodiments of the present invention may be finely crushed red bean paste and/or whole red bean paste in boiled status prepared by boiling red beans in water and crushing the boiled red bean grains while adding sugar or salt thereto. Such prepared red bean paste has excellent palatability, thus being used in a broad range of applications, for example, the production of breads, rice cakes, ice cream and/or shaved ice.

Further, embodiments the present invention relate to a glutinous rice cake with mugwort containing red bean paste, which includes 50 to 60% wt. % of glutinous rice, 20 to 25 wt. % of mugwort, 17 to 23 wt. % of red bean paste, 2 to 3 wt. % of walnut, 0.1 to 1 wt. % of bay salt and 0.5 to 1.5 wt. % of sugar to a total weight of the glutinous rice cake.

According to the glutinous rice cake with mugwort according to embodiments of the present invention, the red bean paste may be a mixture of fine red bean paste and whole red bean paste in a mixing ratio by weight of 2:1 and further include walnut powders.

Hereinafter, the method for manufacturing a glutinous rice cake with mugwort according to embodiments of the present invention will be described in more detail.

(1) Pre-Treatment and Storage of Mugwort

In order to prevent corruption of mugwort and to deactivate enzymes, after gathering mugwort, separating leaves and young stems from the mugwort and washing the same, the mugwort leaves and stems are cut into pieces having a size of ⅛ to 1/12 of an original size by a crusher.

Since mugwort leaves and stems provide synergistic effects on improvement of mouthfeel of crushed glutinous rice cake with mugwort, the mugwort leaves and stems are preferably used by cut, instead of crushing.

The cut mugwort is parboiled in hot water at 100 to 120° C. for 1 to 3 minutes to deactivate enzymes, followed by firstly dehydrating to remove 15 to 25% of water content and storing the mugwort in a freezer at −10 to −30° C.

In embodiments, Halla mountain mugwort (‘Hallasanssuk’) from Jeju-do is usually harvested once a year and is used while storing the same up to 1 year. Therefore, when the residual water content is kept to 75 to 85% by first dehydration, mugwort could hold its original color or flavor well and be easy to conduct freezer storage.

The frozen mugwort may be naturally thawed at room temperature and subjected to second dehydration to remove 35 to 45% water content in the mugwort. The final water content of mugwort ranges from 35 to 45%. Therefore, after mixing the mugwort with glutinous rice soaked in water and secondary materials without adding separate water, the mixture is steamed in a steam cooking pot to prepare a glutinous rice cake with mugwort containing red bean paste. The thawed mugwort is preferably used in an amount of 20 to 25 wt. % to a total 100 wt. % of glutinous rice cake with mugwort.

(2) Pre-Treatment of Glutinous Rice and Mixing Main and Secondary Materials

After purchasing and washing new glutinous rice with pure water, the rice is soaked in water at room temperature for 1 to 3 hours in a non-winter season or for 2 to 4 hours in a winter season. The soaked glutinous rice is used in an amount of 50 to 60 wt. % to a total 100 wt. % of steamed glutinous rice grains with mugwort.

In order to improve taste and physical properties of the steamed glutinous rice grains with mugwort, salt and sugar are used as the secondary material. In particular, to 100 wt. % of the whole glutinous rice cake with mugwort, the salt may be bay salt and used in an amount of 0.1 to 1 wt. %, while the sugar may be used in an amount of 0.5 to 1.5 wt. %.

(3) Steaming Main and Secondary Materials and Preparation of Steamed Glutinous Rice Grains with Mugwort

After adding 20 to 25 wt. % of mugwort, 0.1 to 1 wt. % of bay salt, 0.5 to 1.5 wt. % of sugar to 50 to 60 wt. % of the soaked glutinous rice and evenly mixing the same, the mixture is put in an earthenware steamer and placed in a steam cooking pot, the mixture is steam-heated using steam with a pressure of 1.2 kg/cm² at 100 to 120° C. for 25 to 35 minutes, so as to prepare steamed glutinous rice grains with mugwort.

(4) Crushing Glutinous Rice Grains with Mugwort and Production of Glutinous Rice Cake with Mugwort Containing Red Bean Paste

The cooked glutinous rice grains with mugwort are put in a pounding machine and pounded for 20 to 40 seconds, followed by secondly crushing the first-crushed glutinous rice cake with mugwort in the above pounding machine.

When the steamed glutinous rice grains with mugwort are unevenly crushed, these grains may get put together with mugwort particles and springiness and chewiness felt in the mouth exhibit synergistic effects to thus improve the mouthfeel. Further, disadvantages such as adhesiveness and gumminess are reduced to thus provide better taste of the glutinous rice cake with mugwort.

When a sum of the crushing ratios in the first and second crushing processes becomes 30 to 70 wt. %, the rice cake is filled with the red bean paste including walnut powders in the forming machine, followed by forming the product into a glutinous rice cake with mugwort containing red bean paste.

Hereinafter, the present invention will be described in more detail by means of the following examples and experimental examples. The examples and experimental examples are proposed to illustrate embodiments of the present invention only, and therefore, the scope of the present invention to be protected is not particularly limited thereto.

### Examples 1 to 5 and Comparative Examples 1 to 4

After cutting leaves and stems of mugwort grown in Halla mountain in Jeju-do under sea wind into pieces having a size of 1/9 to 1/11 of an original size and parboiling the mugwort pieces in hot water at 110° C. for 2 minutes to deactivate enzymes, the parboiled mugwort was firstly dehydrated to remove 15 to 25% of water content and stored in a freezer at −20° C. Thereafter, the frozen mugwort was naturally thawed and secondly dehydrated to reach a water content of 40%, followed by mixing the mugwort with the glutinous rice soaked in water as well as secondary materials such as bay salt and sugar.

After evenly mixing the soaked glutinous rice, thawed mugwort and the secondary materials together, the mixture was put in an earthenware steamer and placed in a steam cooking pot, then, heated using steam with a pressure of 1.2 kg/cm² at 110° C. for 30 minutes, thereby preparing steamed glutinous rice grains with mugwort.

After putting the cooked glutinous rice grains with mugwort in a rice cake pounding machine, pounding the same for 30 seconds to obtain first-crushed glutinous rice cake with mugwort and secondly crushing the first-crushed glutinous rice cake with mugwort, this rice cake was filled with red bean paste including walnut powders, followed by forming the product into a glutinous rice cake with mugwort containing red bean paste.

The crushing ratio (%) and contents of individual components (wt. %) are shown in Table 1 below.

TABLE 1

| | Comparative | Comparative | Example | Example | Example | Example | Example | Comparative | Comparative |
|---|---|---|---|---|---|---|---|---|---|
| Category | Example 1 | Example 2 | 1 | 2 | 3 | 4 | 5 | Example 3 | Example 4 |
| Crushing ratio | 15 | 25 | 30 | 40 | 50 | 60 | 70 | 80 | 0 |
| Glutinous rice | 50 | 50 | 50 | 50 | 50 | 50 | 50 | 50 | 50 |
| Pre-treated mugwort | 20 | 20 | 20 | 20 | 20 | 20 | 20 | 20 | 20 |
| Red bean paste | 23 | 23 | 23 | 23 | 23 | 23 | 23 | 23 | 23 |
| Walnut powder | 4.5 | 4.5 | 4.5 | 4.5 | 4.5 | 4.5 | 4.5 | 4.5 | 4.5 |
| Sugar | 1.5 | 1.5 | 1.5 | 1.5 | 1.5 | 1.5 | 1.5 | 1.5 | 1.5 |
| Bay salt | 1 | 1 | 1 | 1 | 1 | 1 | 1 | 1 | 1 |
| Total | 100 | 100 | 100 | 100 | 100 | 100 | 100 | 100 | 100 |

### <Experimental Example 1> Comparison of Physical Properties of Glutinous Rice Cake with Mugwort Containing Red Bean Paste Based on Crushing Ratio

In order to investigate physical characteristics of the glutinous rice cakes with mugwort containing red bean paste produced in Examples 1 to 5 and Comparative Examples 1 to 4, respectively, a texture analyzer (TA-XT2, Stable Micro System, England) was used to determine texture properties.

A size of each sample to be measured was 5×5×2 cm, and a texture profile analysis (TPA) of the sample was determined three times on the basis of a force-distance curve, which is obtained through two times consecutive compression, followed by calculating an average value from the measured values.

The physical properties of the glutinous rice cake with mugwort including hardness, cohesiveness, adhesiveness, springiness, gumminess and chewiness were measured by the texture analyzer, and the measured results are shown in Table 2 below. Conditions for the present measurement are stated as follows.

Sample height: 20 mm, test mode and condition: TPA, pre-test speed: 2.0 mm/sec, main test speed: 1.5 mm/sec, post-test speed; 2.0 mm/sec, compression: 30% of sample thickness, time: 2 sec, braking means: automatic, braking force: 10 g, probe: 50 mm.

TABLE 2

| | Comparative | Comparative | Example | Example | Example | Example | Example | Comparative | Comparative |
|---|---|---|---|---|---|---|---|---|---|
| Category | Example 1 | Example 2 | 1 | 2 | 3 | 4 | 5 | Example 3 | Example 4 |
| Crushing ratio (%) | 15 | 25 | 30 | 40 | 50 | 60 | 70 | 80 | 0 |
| Hardness (g/cm²) | 761.78 | 766.25 | 850.07 | 856.15 | 862.41 | 858.63 | 856.22 | 748.43 | 656.08 |
| Cohesiveness (%) | 0.78 | 0.77 | 0.68 | 0.67 | 0.65 | 0.67 | 0.69 | 0.78 | 0.89 |
| Gumminess (dyne/cm²) | 589.91 | 579.66 | 542.97 | 539.86 | 538.24 | 539.75 | 540.48 | 580.24 | 637.09 |
| Springiness (%) | 0.75 | 0.78 | 0.99 | 1.05 | 1.06 | 1.03 | 1.01 | 0.83 | 0.66 |
| Adhesiveness (g) | −3.92 | −3.63 | −2.68 | −2.66 | −2.62 | −2.57 | −2.68 | −3.86 | −4.15 |
| Chewiness (g) | 474.08 | 481.56 | 515.69 | 523.00 | 539.78 | 540.52 | 538.23 | 487.90 | 463.56 |

As shown in Table 2, it could be seen that the glutinous rice cake with mugwort containing red bean paste according to embodiments of the present invention has noticeably excellent hardness, springiness and chewiness advantageously influencing on the mouthfeel as well as considerably reduced cohesiveness, adhesiveness and gumminess adversely affecting the mouthfeel, compared to controls.

### <Experimental Example 2> Functional Test

In order to investigate functional properties of the glutinous rice cakes with mugwort containing red bean paste produced in Examples 1 to 5 and Comparative Examples 1 to 4, respectively, well-trained panels (males and females, 10 persons in each of teens, twenties, thirties and forties) have participated in the functional tests regarding flavor, taste, texture and whole palatability on the basis of 5-point scale (5 point: very excellent, 4 point: excellent, 3 point: normal, 2 point or less: inadequacy), and the measured results are shown in Table 3 below.

TABLE 3

| | Comparative | Comparative | Example | Example | Example | Example | Example | Comparative | Comparative |
|---|---|---|---|---|---|---|---|---|---|
| Category | Example 1 | Example 2 | 1 | 2 | 3 | 4 | 5 | Example 3 | Example 4 |
| Crushing ratio (%) | 15 | 25 | 30 | 40 | 50 | 60 | 70 | 80 | 0 |
| Flavor | 4.2 | 4.2 | 4.3 | 4.4 | 4.5 | 4.5 | 4.4 | 4.3 | 4.2 |
| Taste | 3.9 | 4.0 | 4.4 | 4.5 | 4.5 | 4.5 | 4.4 | 4.0 | 3.3 |
| Texture | 3.3 | 3.6 | 4.7 | 4.7 | 4.8 | 4.8 | 4.7 | 4.1 | 2.5 |
| Whole palatability | 4.0 | 4.1 | 4.4 | 4.5 | 4.5 | 4.5 | 4.4 | 4.0 | 3.1 |

As shown in Table 3, it can be seen that Examples 1 to 5 including the crushing ratio in a range of 30% to 70% have superior taste, texture and whole palatability, compared to Comparative Examples 1 to 4 including the crushing ratio of less than 30% and exceeding 70%. In particular, Comparative Example 4 without the crushing process has demonstrated very poor taste, texture and whole palatability.

As described above, embodiments of the present invention have been described. However, it will be appreciated by those skilled in the art that various modifications and/or alterations to embodiments of the present invention may be possible without departing from the spirit and scope of the present invention stipulated in the appended claims below.

According to embodiments of the present invention, it is possible to provide a glutinous rice cake with mugwort containing red bean paste, having original taste and flavor due to pre-treatment of the mugwort while having excellent mouthfeel by crushing the steamed glutinous rice. Therefore, the present invention may be usefully applied to the technical field to which the present invention pertains.

What is claimed is:

1. A method for manufacturing a glutinous rice cake with mugwort containing red bean paste, comprising:
(a) cutting mugwort leaves and stems into pieces having a size of ⅛ to 1/12 of an original size, then parboiling the cut mugwort pieces in hot water at 100 to 120° C. for 1 to 3 minutes to deactivate enzymes, and then removing 15 to 25% of water content by firstly dehydrating the parboiled mugwort, followed by freeze-storing the dehydrated product in a freezer at −10 to −30° C.;
(b) naturally thawing the frozen mugwort at room temperature to secondly dehydrate the same and remove 35 to 45% of water content to thus obtain thawed mugwort, soaking glutinous rice in water, mixing the same with a secondary material including bay salt and sugar, and then blending the same with the thawed mugwort, thereby preparing a mixture of glutinous rice and mugwort;
(c) steaming the mixture of glutinous rice and mugwort obtained in the step (b) to prepare steamed glutinous rice grains with mugwort; and
(d) putting the steamed glutinous rice grains with mugwort in a pounding machine and firstly crushing the same, secondly crushing the first-crushed glutinous rice cake with mugwort in the pounding machine, then, filling the rice cake with red bean paste including walnut powders in a forming machine, followed by forming the same into a glutinous rice cake with mugwort containing red bean paste, wherein a whole crushing ratio of the glutinous rice cake with mugwort ranges from 30 to 70%.

2. The method according to claim 1, wherein the glutinous rice cake with mugwort containing red bean paste is manufactured so as to include 50 to 60% wt. % of glutinous rice, 20 to 25 wt. % of mugwort, 17 to 23 wt. % of red bean paste, 2 to 3 wt. % of walnut, 0.1 to 1 wt. % of bay salt and 0.5 to 1.5 wt. % of sugar to a total weight of the rice cake.

3. The method according to claim 1, wherein the red bean paste is a mixture of fine red bean paste and whole red bean paste in a mixing ratio by weight of 2:1.
